(19) United States
(12) Patent Application Publication
(10) Pub. No.: US 2019/0007540 A1
(43) Pub. Date: Jan. 3, 2019

(54) COMMUNICATION HEADSET COMPRISING WIRELESS COMMUNICATION WITH PERSONAL PROTECTION EQUIPMENT DEVICES

(71) Applicant: Honeywell International Inc., Morris Plains, NJ (US)

(72) Inventors: Mehabube Rabbanee SHAIK, (IN); Trym HOLTER, (NO); Swapnil Gopal PATIL, (IN); Praveen Kumar PALACHARLA, (IN); Nagaraju RACHAKONDA, (IN)

(21) Appl. No.: 15/752,853

(22) PCT Filed: Aug. 9, 2016
(86) PCT No.: PCT/US2016/046170

§ 371 Date: Feb. 14, 2018

(30) Foreign Application Priority Data
Aug. 14, 2015 (IN) 2520/DEL/2015

(51) Int. Cl. H04M 1/60; G10L 15/26; G10L 15/22; G10L 13/02; H04R 1/10

(52) U.S. Cl. CPC H04M 1/6066; G10L 15/26; G10L 15/22; G10L 13/02; H04M 2250/74; H04R 2460/01; H04R 2420/07; G10L 2015/223; H04R 1/1091

(57) ABSTRACT

Embodiments of the disclosure include a communication headset, which may comprise active noise cancellation or reduction, configured to wirelessly communicate with one or more PPE devices using voice recognition to process voice inputs from a user. The headset may comprise a voice recognition module configured to receive voice inputs from a user (via a microphone on the headset) and convert the voice inputs to text. The voice inputs may comprise commands that may be sent to the PPE devices, wherein the commands may request information from the PPE devices, such as pressure level, temperature, gas content and level, battery life, etc., and wherein the PPE devices may send a response to the headset comprising that information. The headset may then convert the response to a voice output, which may then be sent to the user via speakers in the headset.

### CROSS-REFERENCE TO RELATED APPLICATIONS

The present application claims priority to India Provisional Patent Application No. 2520/DEL/2015 filed Aug. 14, 2015 by Mehabube Rabbanee Shaik, et. al. and entitled “Communication Headset Comprising Wireless Communication with Personal Protection Equipment Devices,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

While working in an environment with high noise levels, a user may wear a headset that comprises noise reduction or cancellation devices. Additionally, the headset may allow the user to communicate with other users over a radio connection, therefore comprising microphones and speakers to allow for communication. In some cases, a user may also wear personal protection equipment (PPE) while working in hazardous environments, such as a gas detector, a self-contained breathing apparatus (SCBA), a powered air purifying respirator (PAPR), and a low pressure warning device (LPWD).

### SUMMARY

Aspects of the disclosure may include embodiments of a communication headset comprising one or more inward facing microphones; one or more inward facing speakers; a voice recognition module configured to receive voice input from the user via the one or more microphones, and convert the voice input from the user into text; a processor configured to: receive the text output from the voice recognition module; determine if the text output is associated with a command; direct the command to an indicated destination; receive a response to the command; convert the response to a voice output; and send the voice output to the one or more speakers to be communicated to the user; a wireless module configured to, when the indicated destination is an external personal protection equipment (PPE) device, communicate the command wirelessly to the PPE device, and receive a response from the PPE device; and a local control unit configured to, when the indicated destination is the local headset, process the command and generate a response to the command.

Additional aspects of the disclosure may include embodiments of a method for executing commands with a communication headset comprising receiving, by the communication headset, voice input from a user, via at least one microphone in the communication headset; processing the voice input, by a voice recognition module, to convert the voice input into a text output; determining if the text output is associated with a command; when the text output is associated with a command, determining the destination for the command; sending the command to the destination; receiving a response to the command; converting the response to a voice output; and sending the voice output to the user, via speakers in the communication headset.

Other aspects of the disclosure may include embodiments of a communication system comprising one or more personal protection equipment (PPE) devices; and a communication headset comprising: one or more microphones; one or more speakers, wherein the microphones and speakers are located within earbuds within a user's ear; a voice recognition module configured to receive voice input from the user via the one or more microphones, and convert the voice input from the user into text; a processor configured to receive the text output from the voice recognition module; determine if the text is associated with a command; direct the command to an indicated destination; receive a response to the command; convert the response to a voice output; send the voice output to the one or more speakers to be communicated to the user; and a wireless module configured to, when the indicated destination is one of the PPE devices, communicate the command wirelessly to the PPE device, and receive a response from the PPE device.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 illustrates a diagram of a communication headset device configured to wirelessly communicate with one or more PPE devices;

FIG. 2 illustrates an exemplary PPE device;

FIG. 3 illustrates an exemplary PPE device;

FIG. 4 illustrates an exemplary PPE device;

FIG. 5 illustrates another diagram of a communication headset device configured to wirelessly communicate with one or more PPE devices;

FIG. 6 illustrates yet another diagram of a communication headset device configured to wirelessly communicate with one or more PPE devices; and

FIG. 7 illustrates a method for executing commands on a communication headset and a wireless enabled PPE device.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

The following brief definition of terms shall apply throughout the application:

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example;

The terms “about” or “approximately” or the like, when used with a number, may mean that specific number, or alternatively, a range in proximity to the specific number, as understood by persons of skill in the art field; and

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

Embodiments of the disclosure include a communication headset, which may comprise active noise cancellation or reduction, configured to wirelessly communicate with one or more PPE devices.

Current PPE devices may be communicated with a user via displays, visual indications, lights, vibrations, etc., which all require the user to pay attention to the PPE to observe these communications while also focusing on the job or task the user is performing, which may be difficult in the environments the user may be working in, and while a user is wearing the PPE, their vision and hearing may be limited by the PPE. These communications may include parameters, such as pressure level, gas content and level, battery life, etc., as well as alerts and warnings, which are important for a user to notice. Additionally, to adjust any parameters, such as air supply level, a user must manually press buttons to execute that adjustment.

Applicants propose the use of a communication headset, which may already be worn by the user for noise reduction and radio communication purposes, to wirelessly communicate with the PPE devices using voice recognition to process voice inputs from a user. The headset may comprise a voice recognition module configured to receive voice inputs from a user (via a microphone on the headset) and convert the voice inputs to text. The voice inputs may comprise commands that may be sent to the PPE devices, wherein the commands may request information from the PPE devices, such as pressure level, temperature, gas content and level, battery life, etc., wherein the PPE devices may send a response to the headset comprising that information. The headset may then convert the response to a voice output, which may then be sent to the user via speakers in the headset.

Using the headset to communicate with the PPE devices may provide a hands-free way for a user to receive information from the PPE devices without having to divert their attention to look at a display or manually press buttons. The user may be wirelessly connected to the PPE devices at all times, either constantly or periodically. Additionally, warnings and alerts may be sent to the headset (in addition to visual indications) providing another way to ensure that the user is aware of the warnings and alerts. Additionally, the voice communication received from the microphones to the headset may be easy to understand and process, even in a noisy environment, because the voice input is fed through noise reduction modules, and because the microphone is located within the user's ear and therefore partially isolated from the external noise.

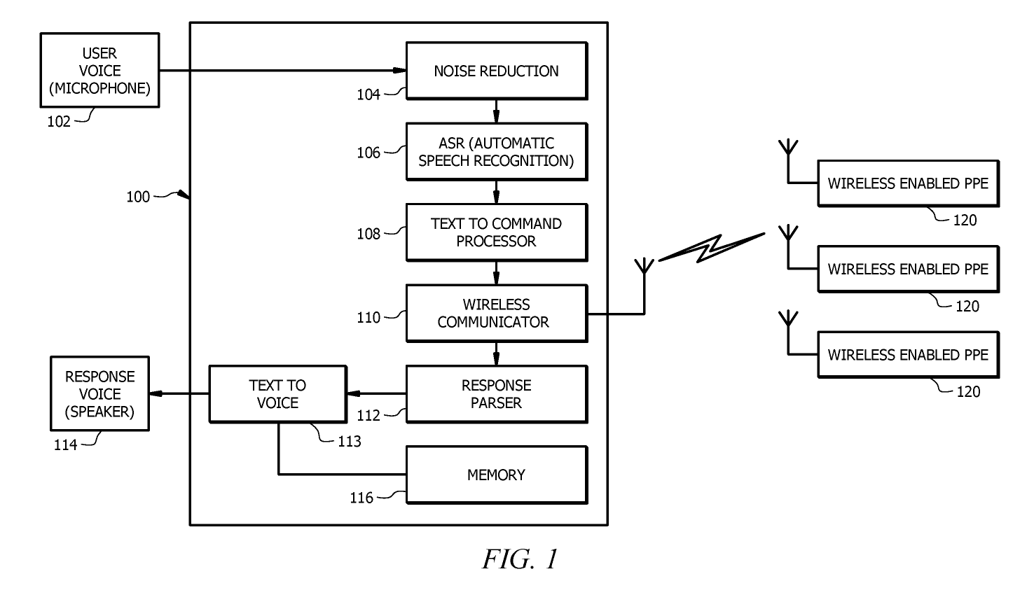

Referring now to FIG. 1, a communication headset device 100 is described, wherein the communication headset 100 comprises voice recognition capabilities. In an embodiment, the communication headset 100 may provide hearing protection, passive and/or active. The communication headset 100 may be used to communicate to and from a user, via a microphone 102 and a speaker 114. In some embodiments, the communication headset 100 may be enabled to communicate with one or more PPE device 120. The communication headset 100 may communicate commands and/or requests to the PPE devices 120, wherein the PPE device 120 may respond according to the command or request.

In the embodiment shown, the communication headset 100 may detect a user's voice via the microphone 102, wherein the voice input may be processed (or filtered) by a noise reduction module 104 as well as an automatic speech recognition (ASR) device 106. The ASR may determine the words said by the user and output text of those determined words. Then, a processor 108 may receive the text and determine if there is a command associated with that text. The commands may be predefined and stored in a look-up table that may be accessed and/or stored by the processor 108. If a command is identified by the processor 108, the command may be communicated wirelessly via a wireless communicator 110 (comprising a transmitter and receiver), such as via radio, Bluetooth, Wi-Fi, etc., to one or more of the wireless enabled PPE devices 120. The PPE device 120 may send a response to the command to the wireless communicator 110, wherein the response may be processed by a parser 112 to produce a text of the response. The parser 112 may comprise a software module configured to receive the response in an integer format and convert the response to a text format. The response may then be converted from text to voice by a converter 113, and communicated to a user via the speaker 114. For example, a command may be issued asking for the current temperature, such as “Current Temperature”. The processor 108 may identify the command and communicate the command to the appropriate PPE (such as a thermometer) 120. The PPE 120 may send the response to the command, which may be received by the wireless communicator 110. In some embodiments, the response may be received in integer format, such as 0x00FD (which is 253 in integer format). The parser 112 may have an expected format for the response based on the command that was issued, and the parser 112 may convert the integer format into text, such as “twenty five point three degrees” and forward this text to the converter 113, wherein the text may be played out-loud via the speaker 114. In some embodiments, the converter 113 may comprise a text synthesizer module. In some embodiments, the converter 113 may comprise typical software, such as VeeaR's Quick T2SI Lite or a similar product.

In some embodiments, the communication headset 100 may comprise a memory 116, which may communicate with one or more other elements of the communication headset 100. In some embodiments, the text to voice converter 113 may access the memory 116 when converting text. In some embodiments, the text to command processor 108 may access the memory 116, wherein a log-table of commands may be stored in the memory 116. In some embodiments, responses from the PPE devices 120 may be stored in the memory 116.

In some embodiments, the communication headset 100 may comprise a PTT button, wherein when the PTT button is pressed, the ASR module 106 may be disabled, and the user's voice may be communicated via a radio output, for example, allowing radio communication with other personnel. However, when a user speaks without pressing the PTT button, the ASR module 106 may receive the voice input and the text to command processor 108 may search for a “trigger word” that is associated with a command. In some embodiments, the command may include indication for the PPE device 120 that should receive the command, or if the command is a local command meant for the headset 100. Local commands for the communication headset 100 may include adjusting volume output, determining battery life of the headset, etc. One example of a local command may be “PPEs”, which may generate a response that reads out the list of PPE devices 120 that are connected to/communicating with the headset 100. Another example of a local command may be “Max SPL”, which may generate a response of the maximum sound pressure level recorded by the headset 100. Another example of the local command may be “Diagnose”, which may initiate an internal diagnostics procedure on the headset 100, and may generate a response with the results of the internal diagnostics procedure. Another example of a local command may be “Volume Up” and/or “Volume Down”, which may increase or decrease the volume output from the headset 100.

In some embodiments, each command may be associated with a specific PPE device 120, wherein different commands may be used for each PPE device 120. In some embodiments, a trigger word may be used to indicate the destination of the command before the command is said by the user. The trigger word may indicate the channel that should be used, wherein each PPE device is on a separate communication channel. Additionally, the local headset 100 may be on a separate communication channel. In this case, the PPE devices 120 may only receive the commands meant for them, as processed by the text to command processor 108. Alternatively, all commands may be broadcast to all of the PPE devices 120, wherein each PPE device 120 has a set of commands that the device will respond to. Therefore, each device may receive all of the commands, but may only respond to the commands associated with that device 120. PPE may constantly or periodically transmit information to the headset—status, alerts, etc.

One example of a PPE command may be “Cylinder Pressure”, which may be directed to an SCBA in communication with the headset 100, and may generate a response of the current pressure level in the cylinder of the SCBA. Another example of a PPE command may be “Oxygen Level”, which may be directed to a gas sensor in communication with the headset 100, and may generate a response of the current oxygen level indicated by the gas sensor. Another example of a PPE command may be “Mask Pressure”, which may be directed to a PAPR in communication with the headset 100, and may generate a response of the current pressure within the mask of the PAPR. Each of the PPE devices 120 may comprise sensors or other indicators operable to detect the information that is requested via the headset 100, such as pressure sensors, gas sensors, temperature sensors, etc.

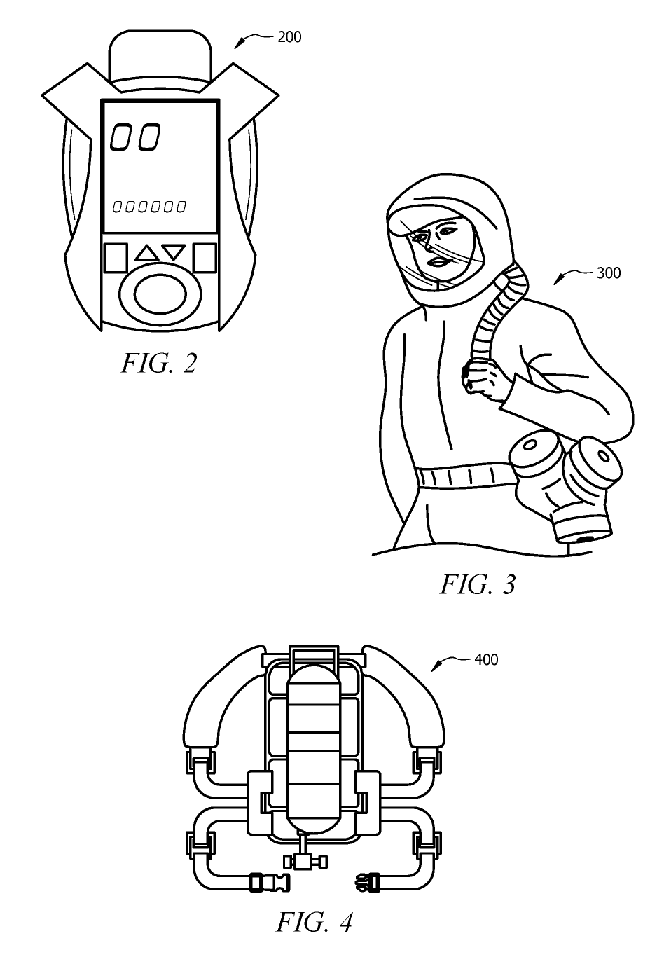

FIGS. 2-4 illustrate exemplary PPE devices that may be enabled to communicate wirelessly with a communication headset (as described in FIG. 1). The PPE devices may receive commands from the communication headset and send responses to the communication headset, wherein the responses may comprise request information about the PPE device. The PPE devices may all comprise sensors for detecting parameters associated with the PPE device, such as pressure, temperate, humidity, gas levels, etc. In some embodiments, the PPE devices 120 may only send information to the communication headset 100, as requested. In other embodiments, the PPE devices 120 may be capable of adjusting certain parameters and settings based on commands received from the communication headset 100.

FIG. 2 illustrates a gas detector 200 that may wirelessly communicate with a communication headset. The gas detector 200 may communicate information to the communication headset, such as gas identification, gas levels, alarms, battery life, etc. FIG. 3 illustrates a PAPR 300 that may communicate information to the communication headset, such as pressure level within the PAPR 300 and/or temperature. FIG. 4 illustrates an SCBA 400 that may communicate information to the communication headset, such as cylinder pressure and/or temperature. The PPE device may also comprise a LPWD.

In some embodiments, the PPE devices 120 may comprise a processor operable to receive, process, and send information to and from the headset 100. In some embodiments, the PPE devices 120, in addition to responding to received commands, may automatically generate periodic updates to be communicated to the communication headset 100. For example, the PPE device 120 may periodically send status updates of the data that is listed above. Additionally, the PPE device 120 may automatically generate an update if there is a warning, emergency, or alarm. Predefined limits may be programmed into the PPE device 120, and when those limits are exceeded, a warning may be generated by the PPE device 120 and sent to the communication headset 100. In another embodiment, the predefined limits may be programmed into the headset 100, wherein the warning may be generated by the headset 100 when the headset 100 receives the information from the PPE device 120 and determines that a limit has been exceeded. The PPE device 120 may be continually forwarding information to the headset 100, wherein the information may be processed by the headset 100 to generate updates and/or alarms for the user.

In some embodiments, the PPE devices 120 may communicate via binary data, wherein the commands sent to the PPE devices 120 may be in the form of binary data, and the responses received from the PPE devices 120 may comprise binary data. In this case, the text to command processor 108 may output the command in binary. Also, the response parser 112 may convert the received binary response to text, before the text is converted to voice.

In some alternative embodiments, the PPE devices 120 may be equipped with a voice recognition device, wherein the commands may be sent to the PPE device 120 directly as the voice command received from the user, without being processed by the headset or converted into text and then binary data. In some embodiments, the communication headset 100 may determine if the PPE device 120 is enabled for binary communication or voice communication and may send the commands in the correct form.

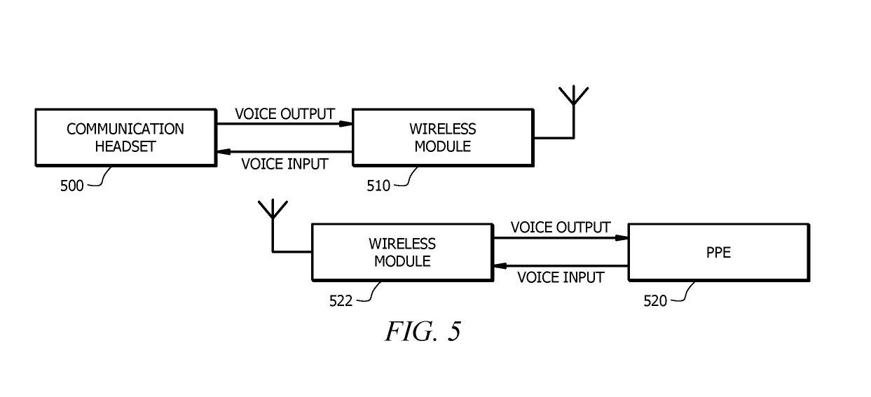

FIG. 5 illustrates a diagram of a communication headset 500 and a PPE device 520, wherein the communication headset 500 and PPE device 520 communicate over a wireless connection, and wherein the PPE device 520 is enabled with voice recognition. The communication headset 500 may comprise (or be connected to) a wireless module 510 (as described above). The wireless module 510 may receive voice output from the communication headset 500 and send voice input (received by the wireless module 510 from the PPE device 520) to the communication headset 500. The PPE device 520 may also comprise (or be connected to) a wireless module 522. The wireless module 522 may send voice output from the communication headset 500 to the PPE device 520, wherein the PPE device 520 may process the voice output (which may comprise a command) and generate a voice response to the command. The PPE device 520 may then send the response as voice input to the communication headset 500 via the wireless modules 510 and 522. In some embodiments, the wireless modules 510 and 522 may comprise Bluetooth modules, wherein the wireless modules 510 and 522 may communicate via a Bluetooth connection.

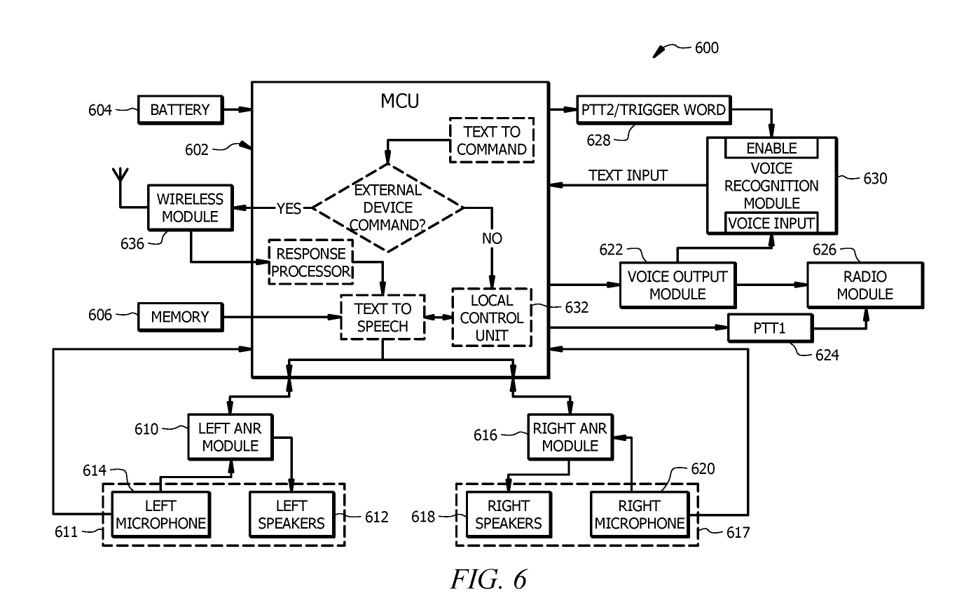

FIG. 6 illustrates a more in-depth diagram of a communication headset 600 (similar to the communication headset described above). The communication headset 600 may comprise a microprocessor unit (MCU) 602, wherein the MCU 602 may be powered by a battery 604, and may access a memory 606. The MCU 602 may facilitate communication between the different elements of the communication headset 600. The communication headset 600 may also comprise a wireless module 636 for communicating wirelessly with other devices (such as PPE devices). The communication headset 600 may also comprise a radio module 626 for communicating via radio with other radio-enabled devices.

The communication headset 600 may comprise a left ANR module 610, wherein the left ANR module 610 may be associated with the left ear of a user. The left ANR module 610 may communicate with one or more left microphone(s) 614 and one or more left speaker(s) 612, wherein the microphone 614 and speaker 612 are located within a left earbud 611 within a user's ear. The communication headset 600 may also comprise a right ANR module 616, wherein the right ANR module 616 may be associated with the right ear of a user. The right ANR module 616 may communicate with one or more right microphone(s) 620 and one or more right speaker(s) 618, wherein the microphone 620 and speaker 618 are located within a right earbud 617 within a user's ear. The left ANR module 610 and the right ANR module 616 may send information received from the microphones 614 and 620 to the MCU 602 to be processed. In some embodiments, the microphones 614 and 620 may also communicate directly to the MCU 602. The ANR modules 610 and 616 may also receive information from the MCU 602 to be communicated to a user via the speakers 612 and 618. The voice communication received from the microphones to the MCU 602 may be easy to understand and process, even in a noisy environment, because the voice input is fed through the ANR modules, and because the microphone is located within the user's ear and therefore partially isolated from the external noise.

In some embodiments, the communication headset 600 may comprise some sort of passive noise reduction, or another type of noise reduction, wherein the microphone that receives the voice communication is located between the noise reduction and the user's ear/head. Also, in some embodiments, the microphone that is operable to receive the voice communication may be located on the exterior of the headset 600.

The communication headset 600 may also comprise a voice output module 622 configured to receive all voice output received by the microphones 614 and 620. In some embodiments, a user may indicate that the voice output is radio communication by pressing a PTT button 624, wherein the voice output module 622 may then direct the voice output to the radio module 626 (which may comprise a radio, phone, or other similar communication device). This method may be used when a user wishes to send radio communication to other users.

In some embodiments, a user may indicate that the voice output is a command meant for either the communication headset, or a PPE device. In some embodiments, the user may indicate that the voice output is a command by pressing a second PTT button 628. In another embodiment, the user may indicate that the command is a command for the communication headset 600 by pressing the second PTT button 628, and may indicate that the command is for a PPE device by using a trigger word. Alternatively, the user may indicate that the command is a command for a PPE device by pressing the second PTT button 628, and may indicate that the command is for the communication headset 600 by using a trigger word. In another embodiment, the user may indicate that the voice output is a command by user a trigger word. In some embodiments, the headset 600 may utilize multiple communication channels for the PPE devices and/or the local headset. A trigger word may be used to identify the channel for which the user wishes to issue a command. For example, a user may say “Local” as a trigger word to indicate that the command should be sent to the local headset 600. Then the user may say “battery” to request the current battery level of the local headset 600. The text to command processor of the MCU 602 may identify the command and scans the local look-up table. If the response is available locally, the MCU 602 may respond with the answer, such as “60%” and/or “2 hours remaining” or another type of battery life indication. Then, the response may be converted to voice/audio and communicated to the user via the speakers 612, 618 of the headset 600.

If the user indicates that the voice output is a command (for either the communication headset 600 or a PPE device, as described above), the voice output module 622 may direct the voice output to a voice recognition module 630 (which may also be known as an ASR module). The use of either a second PTT button 628 and/or a trigger word may enable the voice recognition module 630 to receive voice input from the voice output module 622. In some embodiments, the voice recognition module 630 may be initially set up generally to communicate with any user, and the voice recognition module 630 may also be enabled to adapt to a specific user and learn the user's voice.

The voice recognition module 630 may convert the received voice input (from the microphones 614 and 620 via the MCU 602 and the voice output module 622) to a text input sent to the MCU 602, wherein the MCU 602 may process the text input to determine the command associated with the text. The MCU 602 may access a predefined set of commands and associations for those commands, which may, in some embodiments, be stored in the memory 606.

The MCU 602 may then determine if the command is an internal command (meant for the communication headset 600) or an external command (meant for a PPE device). In some embodiments, this may be determined using the PTT button and/or trigger word (as described above). In some embodiments, each command may be predefined and associated with a destination for the command. If the command is determined to be an internal command, it may be sent to a local control unit 632, which may implement the command. The local control unit 632 may then generate a response to the command, which may be converted from text to voice by the MCU 602, and may be communicated to the user via the left and right speakers 612 and 618. In some embodiments, the MCU 602 may access stored data in the memory 606 to determine the voice output from the text response.

If the command is determined to be an external command, it may be sent to the wireless module 636, which may then forward the command over a wireless connection to a PPE device. In some embodiments, the command may be sent to a specific PPE device based on the predefined associations of the command. In other embodiments, the command may be broadcast to multiple PPE devices worn by the user, wherein all PPE devices may receive the command, but the PPE device that is associated with the command may respond to the command. In some embodiments, the command may be communicated to the PPE device(s) in binary form.

Once a PPE device receives the command, the wireless module 636 may receive a response from the PPE device, which may be processed by the MCU 602. In some embodiments, the response may be received in binary form and may be converted to text. The response may then be converted from text to voice by the MCU 602, and may be communicated to the user via the left and right speakers 612 and 618. In some embodiments, the MCU 602 may access stored data in the memory 606 to determine the voice output from the text response.

In some embodiments, the communication headset 600 may comprise, or may be connected to, a telemetry module, which may be configured to store the information received from the PPE devices. In some embodiments, a wireless module may be connected to an existing PPE device to enable the device to communicate wirelessly with the communication headset 600.

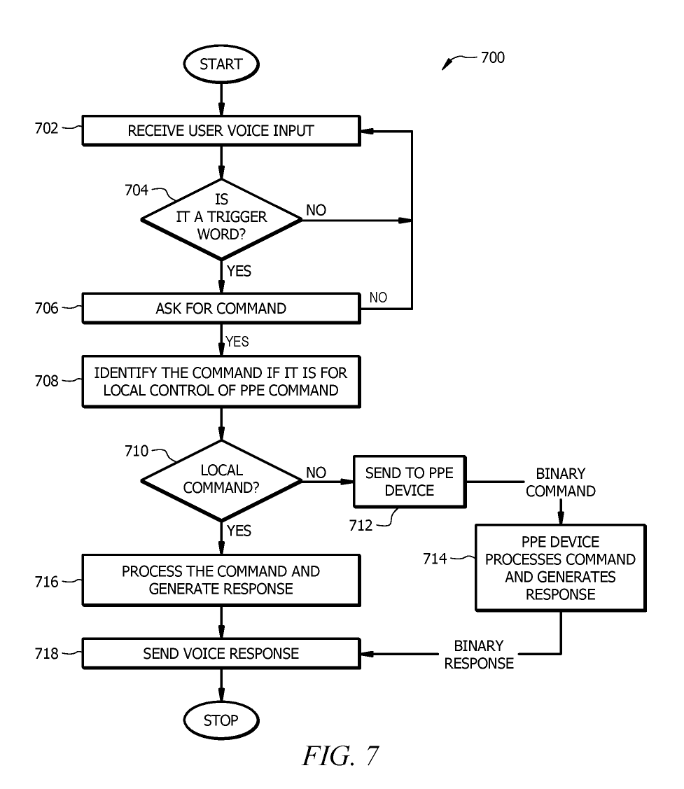

FIG. 7 illustrates a method 700 for executing commands on a communication headset and a wireless enabled PPE device. In the embodiment shown in FIG. 7, the method may comprise using a trigger word to indicate the destination of the command, such as “headset”, “local”, “gas detector”, “SCBA”, “PAPR”, etc., before stating the command. This may direct the command to the correct device.

In some embodiments, if the headset does not recognize the voice input as a trigger word or a command, it may send a response to the user indicating that the voice input was not recognized. For example, the headset may respond “voice input not recognized” and may additionally suggest possible commands or trigger words that would be recognized.

At step 702, the communication headset may receive voice input from a user. During use of the communication headset, the headset may be in a state of waiting for voice input, and may respond to received voice input. At step 704, the communication headset may determine if the received voice input is a trigger word. If it is not a trigger word, the headset may continue waiting to receive voice input from the user. If the voice input is a trigger word, the headset may send a response to the user (via speakers) asking for the command at step 706. If the next voice input is not a command, the headset may continue waiting to receive voice input from the user. If the next voice input is a command, at step 708, the command may be processed to identify the command and the destination of the command, which may be the local control of the headset or a PPE device. At step 710, it may be determined if the command is a local command.

If the command is not a local command, at step 712, it may be sent to a PPE device. In some embodiments, the command may be sent in binary form to the PPE device. At step 714, the PPE device may process the received command, may generate a response for the communication headset, and may send the response to the communication headset. In some embodiments, the response may be sent in binary form. At step 718, the received response may be sent to the user via the speakers of the communication headset.

If the command is a local command, at step 716, the command may be processed locally by the communication headset, and a response to the command may be generated. Then, at step 718, the response may be sent to the user via the speakers of the communication headset. The method 700 may be repeated as voice input is received from the user by the communication headset.

In a first embodiment, a communication headset comprises one or more inward facing microphones; one or more inward facing speakers; a voice recognition module configured to receive voice input from the user via the one or more microphones, and convert the voice input from the user into text; a processor configured to receive the text output from the voice recognition module; determine if the text output is associated with a command; direct the command to an indicated destination; receive a response to the command; convert the response to a voice output; and send the voice output to the one or more speakers to be communicated to the user; a wireless module configured to, when the indicated destination is an external PPE device, communicate the command wirelessly to the PPE device, and receive a response from the PPE device; and a local control unit configured to, when the indicated destination is the local headset, process the command and generate a response to the command.

A second embodiment can include the communication headset of the first embodiment, further comprising one or more ANR modules connected to the microphone(s) and speaker(s), configured to reduce the noise in the ears of the user.

A third embodiment can include the communication headset of the first or second embodiments, further comprising a radio module configured to communicate a user's voice over a radio connection to other users having radio communication devices.

A fourth embodiment can include the communication headset of the third embodiment, further comprising a PTT button configured to indicate that the user's voice input should be sent to the radio module.

A fifth embodiment can include the communication headset of the fourth embodiment, further comprising a second PTT button configured to indicate that the user's voice input should be sent to the voice recognition module.

A sixth embodiment can include the communication headset of any of the first to fifth embodiments, wherein the voice input from the user is sent to the voice recognition module if the voice input includes a trigger word indicating that the voice input will include a command.

A seventh embodiment can include the communication headset of any of the first to sixth embodiments, wherein the PPE device comprises one or more of a gas detector, a SCBA, a PAPR, a LPWD, or a combination thereof.

An eighth embodiment can include the communication headset of any of the first to seventh embodiments, wherein the PPE devices are enabled to communicate in binary form, and wherein the processor is further configured to convert the command to binary form from the text output, and convert the response received from the PPE device from binary form to text, before converting the response to a voice output.

In a ninth embodiment of the disclosure, a method for executing commands with a communication headset comprises receiving, by the communication headset, voice input from a user, via at least one microphone in the communication headset; processing the voice input, by a voice recognition module, to convert the voice input into a text output; determining if the text output is associated with a command; when the text output is associated with a command, determining the destination for the command; sending the command to the destination; receiving a response to the command; converting the response to a voice output; and sending the voice output to the user, via speakers in the communication headset.

A tenth embodiment can include the method of the ninth embodiment, wherein the destination comprises a local control unit in the communication headset, and wherein the command is directed to the headset.

An eleventh embodiment can include the method of the ninth or tenth embodiments, further comprising receiving an automatically generated message from a PPE device, that is received without sending a command, wherein the message comprises a warning or alert.

A twelfth embodiment can include the method of any of the ninth to eleventh embodiments, wherein the destination comprises an external PPE device, wherein sending the command to the destination comprises sending the command wirelessly to the PPE device, and wherein receiving the response to the command comprises wirelessly receiving a response from the PPE device.

A thirteenth embodiment can include the method of any of the ninth to twelfth embodiments, further comprising converting the command to binary form from the text output; and converting the response from binary form to text, before converting the response to a voice output.

A fourteenth embodiment can include the method of any of the ninth to thirteenth embodiments, wherein determining the destination for the command comprises receiving a trigger word from the user, and identifying the destination associated with the trigger word.

A fifteenth embodiment can include the method of the any of the ninth to fourteenth embodiments, wherein determining the destination for the command comprises receiving an input from a button on the headset, and identifying the destination associated with the button.

A sixteenth embodiment can include the method of any of the ninth to fifteenth embodiments, further comprising determining that the voice input is radio communication, and forwarding the voice input via a radio communication channel to another communication headset.

A seventeenth embodiment can include the method of any of the ninth to fifteenth embodiments, wherein determining the voice input is radio communication comprises receiving input from a PTT button on the headset.

In an eighteenth embodiment, a communication system comprises one or more personal protection equipment (PPE) devices; and a communication headset comprising one or more microphones; one or more speakers, wherein the microphones and speakers are located within earbuds within a user's ear; a voice recognition module configured to receive voice input from the user via the one or more microphones and convert the voice input from the user into text; a processor configured to receive the text output from the voice recognition module; determine if the text is associated with a command; direct the command to an indicated destination; receive a response to the command; convert the response to a voice output; send the voice output to the one or more speakers to be communicated to the user; and a wireless module configured to, when the indicated destination is one of the PPE devices, communicate the command wirelessly to the PPE device, and receive a response from the PPE device.

A nineteenth embodiment can include the communication system of the eighteenth embodiment, further comprising a left ANR module connected to a left microphone and a left speaker configured to reduce the noise in the left ear of the user; and a right ANR module connected to a right microphone and a right speaker configured to reduce the noise in the right ear of the user.

A twentieth embodiment can include the communication system of the eighteenth or nineteenth embodiments, further comprising a radio module configured to communicate a user's voice over a radio connection to other users having radio communication devices.

A twenty-first embodiment can include the communication system of any of the eighteenth to twentieth embodiments, further comprising a PTT button configured to indicate that the user's voice input should be sent to the radio module.

A twenty-second embodiment can include the communication system of any of the eighteenth to twenty-first embodiments, further comprising a second PTT button configured to indicate that the user's voice input should be sent to the voice recognition module.

A twenty-third embodiment can include the communication system of any of the eighteenth to twenty-second embodiments, wherein the voice input from the user is sent to the voice recognition module if the voice input includes a trigger word indicating that the voice input will include a command.

A twenty-fourth embodiment can include the communication system of any of the eighteenth to twenty-third embodiments, further comprising a local control unit configured to, when the indicated destination is the local headset, process the command and generate a response to the command.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above, but is defined by the claims which follow, that scope including all equivalents of the subject matter of the claims. Each and every claim is incorporated as further disclosure into the specification, and the claims are embodiment(s) of the present invention(s). Furthermore, any advantages and features described above may relate to specific embodiments, but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Use of broader terms, such as comprises, includes, and having should be understood to provide support for narrower terms, such as consisting of, consisting essentially of, and comprised substantially of Use of the term “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system, or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

1-15. (canceled)

16. A communication headset comprising:
one or more inward facing microphones;
one or more inward facing speakers;
a voice recognition module configured to receive voice input from the user via the one or more microphones, and convert the voice input from the user into text;
a processor configured to:
receive the text output from the voice recognition module;
determine if the text output is associated with a command;
direct the command to an indicated destination;
receive a response to the command;
convert the response to a voice output; and
send the voice output to the one or more speakers to be communicated to the user;
a wireless module configured to, when the indicated destination is an external personal protection equipment (PPE) device, communicate the command wirelessly to the PPE device, and receive a response from the PPE device; and
a local control unit configured to, when the indicated destination is the local headset, process the command and generate a response to the command.

17. The headset of claim 16, further comprising one or more active noise reduction (ANR) modules connected to the microphone(s) and speaker(s), configured to reduce the noise in the ears of the user.

18. The headset of claim 16, further comprising a radio module configured to communicate a user's voice over a radio connection to other users having radio communication devices.

19. The headset of claim 18, further comprising a push to talk (PTT) button configured to indicate that the user's voice input should be sent to the radio module.

20. The headset of claim 19, further comprising a second PTT button configured to indicate that the user's voice input should be sent to the voice recognition module.

21. The headset of claim 16, wherein the voice input from the user is sent to the voice recognition module if the voice input includes a trigger word indicating that the voice input will include a command.

22. The headset of claim 16, wherein the PPE device comprises one or more of a gas detector, a self-contained breathing apparatus (SCBA), a powered air purifying respirator (PAPR), a low pressure warning device (LPWD), or combination thereof.

23. The headset of claim 16, wherein the PPE devices are enabled to communicate in binary form, and wherein the processor is further configured to convert the command to binary form from the text output, and convert the response received from the PPE device from binary form to text, before converting the response to a voice output.

24. A method for executing commands with a communication headset comprising:
receiving, by the communication headset, voice input from a user, via at least one microphone in the communication headset;
processing the voice input, by a voice recognition module, to convert the voice input into a text output;
determining if the text output is associated with a command;
when the text output is associated with a command, determining the destination for the command;
sending the command to the destination;
receiving a response to the command;
converting the response to a voice output; and
sending the voice output to the user, via speakers in the communication headset.

25. The method of claim 24, wherein the destination comprises a local control unit in the communication headset, and wherein the command is directed to the headset.

26. The method of claim 24, further comprising receiving an automatically generated message from a PPE device, that is received without sending a command, wherein the message comprises a warning or alert.

27. The method of claim 24, wherein the destination comprises an external personal protection equipment (PPE) device, wherein sending the command to the destination comprises sending the command wirelessly to the PPE device, and wherein receiving the response to the command comprises wirelessly receiving a response from the PPE device.

28. The method of claim 24, further comprising:
converting the command to binary form from the text output; and
converting the response from binary form to text, before converting the response to a voice output.

29. The method of claim 24, wherein determining the destination for the command comprises receiving a trigger word from the user, and identifying the destination associated with the trigger word.

30. The method of claim 24, wherein determining the destination for the command comprises receiving an input from a button on the headset, and identifying the destination associated with the button.

31. The method of claim 24, further comprising determining that the voice input is radio communication, and forwarding the voice input via a radio communication channel to another communication headset.

32. The method of claim 24, wherein determining the voice input is radio communication comprises receiving input from a push to talk (PTT) button on the headset.

33. A communication system comprising:
one or more personal protection equipment (PPE) devices; and
a communication headset comprising:
one or more microphones;
one or more speakers, wherein the microphones and speakers are located within earbuds within a user's ear;
a voice recognition module configured to, receive voice input from the user via the one or more microphones, and convert the voice input from the user into text;
a processor configured to:
receive the text output from the voice recognition module;
determine if the text is associated with a command;
direct the command to an indicated destination;
receive a response to the command;
convert the response to a voice output;
send the voice output to the one or more speakers to be communicated to the user; and
a wireless module configured to, when the indicated destination is one of the PPE devices, communicate the command wirelessly to the PPE device, and receive a response from the PPE device.

34. The headset of claim 33, further comprising:
a left active noise cancellation (ANR) module connected to a left microphone and a left speaker configured to reduce the noise in the left ear of the user; and
a right ANR module connected to a right microphone and a right speaker configured to reduce the noise in the right ear of the user.

35. The headset of claim 33, further comprising a radio module configured to communicate a user's voice over a radio connection to other users having radio communication devices.
